(19) United States
(12) Patent Application Publication
(10) Pub. No.: US 2015/0378939 A1
(43) Pub. Date: Dec. 31, 2015

(54) MEMORY MECHANISM FOR PROVIDING SEMAPHORE FUNCTIONALITY IN MULTI-MASTER PROCESSING ENVIRONMENT

(71) Applicant: ANALOG DEVICES, INC., Norwood, MA (US)

(72) Inventor: Ahmed Ali Mohamed, Canton, MA (US)

(73) Assignee: ANALOG DEVICES, INC., Norwood, MA (US)

(21) Appl. No.: 14/317,954

(22) Filed: Jun. 27, 2014

(51) Int. Cl. G06F 13/16; G06F 13/364; G06F 13/40

(52) U.S. Cl. CPC G06F 13/1663; G06F 13/1684; G06F 13/4022; G06F 13/364

(57) ABSTRACT

A memory mechanism for providing semaphore functionality in a multi-master processing environment is disclosed. An exemplary memory unit includes a memory controller that manages access to a shared memory. The memory controller includes a semaphore context monitor associated with each master having access to the shared memory. A semaphore context monitor associated with a semaphore-capable master is activated by the semaphore-capable master (for example, by exclusive request signal(s) received by memory controller from semaphore-capable master). A semaphore context monitor associated with a non-semaphore-capable master is activated by the memory controller (for example, by exclusive request signal(s) generated by the memory controller). The memory controller can include a semaphore address command mechanism configured to derive a semaphore command from a memory access request received from the non-semaphore-capable master and activate the semaphore context monitor when the semaphore command specifies exclusive access.

### TECHNICAL FIELD

The present disclosure relates generally to synchronization in a processing environment, and more particularly, to memory mechanisms for providing semaphore functionality in a processing environment.

### BACKGROUND

A processing system can include multiple masters that share resources, such as a memory of the processing system. Semaphores are often implemented to manage and synchronize access to the shared resources. Semaphores can be (1) uninterruptible, such that a master can use a shared resource (or a portion thereof) without interference from other masters or (2) interruptible, such that a master is notified when another master interferes with its access to the shared resource (or portion thereof). Though many masters have semaphore capability, implementing semaphore mechanisms to access shared resources, a heterogeneous processing system often includes masters without such semaphore capability. Accordingly, although existing mechanisms for synchronizing access to shared resources in multi-master processing environments have been generally adequate for their intended purposes, they have not been entirely satisfactory in all respects.

### BRIEF DESCRIPTION OF DRAWINGS

The present disclosure is best understood from the following detailed description when read with the accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1 is a schematic block diagram of an exemplary processing system according to various aspects of the present disclosure.

FIG. 2 is a schematic block diagram of an exemplary memory mechanism that supports semaphore functionality for both semaphore-capable and non-semaphore-capable masters, which can be implemented by the processing system of FIG. 1, according to various aspects of the present disclosure.

FIG. 3 is a state diagram for an exclusive mechanism for providing exclusive memory access, which can be implemented by the memory mechanism of FIG. 2, according to various aspects of the present disclosure.

FIG. 4A is a flowchart of an exemplary method for supporting exclusive access of a shared resource by a semaphore-capable master of a processing system, such as the processing system described with reference to FIG. 1 and FIG. 2, and FIG. 3, according to various aspects of the present disclosure.

FIG. 4B is a flowchart of an exemplary method for supporting exclusive access of a shared resource by a non-semaphore-capable master of a processing system, such as the processing system described with reference to FIG. 1 and FIG. 2, and FIG. 3, according to various aspects of the present disclosure.

### OVERVIEW OF EXAMPLE EMBODIMENTS

A memory mechanism for providing semaphore functionality in a multi-master processing environment is disclosed. An exemplary memory unit includes a memory controller that manages access to a shared memory. The memory controller includes a semaphore context monitor associated with each master having access to the shared memory. A semaphore context monitor associated with a semaphore-capable master is activated by the semaphore-capable master (for example, by exclusive read request signal(s) received by memory controller from semaphore-capable master). A semaphore context monitor associated with a non-semaphore-capable master is activated by the memory controller (for example, by exclusive read request signal(s) generated by the memory controller). The memory controller can include a semaphore address command mechanism configured to derive a semaphore command from a memory access request received from the non-semaphore-capable master and activate the semaphore context monitor when the semaphore command specifies exclusive access. The memory controller can further include a semaphore status mechanism configured to return a status of an exclusive access to a master, such as the non-semaphore-capable master.

In various implementations, the semaphore address command mechanism includes a decoder configured to derive the semaphore command from a memory address associated with the memory access request and generate a memory access control signal to facilitate access to the memory by the master. The decoder may be configured to generate an exclusive access request signal, such as an exclusive read request signal, that activates the semaphore context monitor when the semaphore command specifies exclusive access, such as an exclusive read. In various implementations, the decoder determines whether the memory address associated with the memory access request is directed to a first address range or a second address range, wherein the first address range indicates a normal access request and the second address range indicates an exclusive access request. The semaphore address command mechanism may be configured to generate an exclusive request signal to activate the semaphore context monitor associated with the master when the memory address is directed at the second address range. In various implementations, the semaphore context monitor has an active state and an inactive state, wherein the semaphore context monitor is configured to store a memory address associated with the memory access request when in the exclusive active state. The semaphore context monitor is configured to enter the inactive state when the memory controller receives a memory write request having an associated memory address that matches the memory address stored by the semaphore context monitor.

### DETAILED DESCRIPTION OF EXAMPLE EMBODIMENTS

A processing system can include various masters that share slaves (also referred to as peripherals), for example, where more than one master shares a memory. Semaphores, constructed from hardware and/or software, are often implemented to manage and synchronize access to shared resources, such as the shared memory. An exemplary semaphore can be implemented as a software routine using a robust underlying hardware mechanism that supports instruction sequences (such as test-and-set and/or read-modify-write) that are (1) uninterruptible, such that a master can use a shared resource (or a portion thereof) without interference from other masters or (2) interruptible, such that a status (flag) can be provided to a master indicating whether another master interfered with the instruction sequence. Though many masters have semaphore capability (referred to herein as semaphore-capable masters), for example, by providing specific hardware instructions for implementing such instruction sequences, a heterogeneous processing system often includes masters without such capability (referred to herein as non-semaphore-capable masters). In such situations, synchronizing events in the heterogeneous processing system, such as access to the shared memory, can become problematic, particularly when constructing a shared semaphore memory.

The following disclosure provides a memory mechanism that provides semaphore functionality in a multi-master processing environment, such that a heterogeneous processing system can effectively and efficiently manage and synchronize access to shared memory by both semaphore-capable masters and non-semaphore-capable masters. As discussed further below, the memory mechanism enables non-semaphore-capable masters and semaphore-capable masters to communicate via shared semaphore memory, and supports exclusive access of shared memory by both non-semaphore-capable masters and semaphore-capable masters. The memory mechanism and processing system configurations described herein can enhance synchronization in processing environments, while minimizing processing overhead. Different embodiments may have different advantages, and no particular advantage is necessarily required of any of the embodiments described herein.

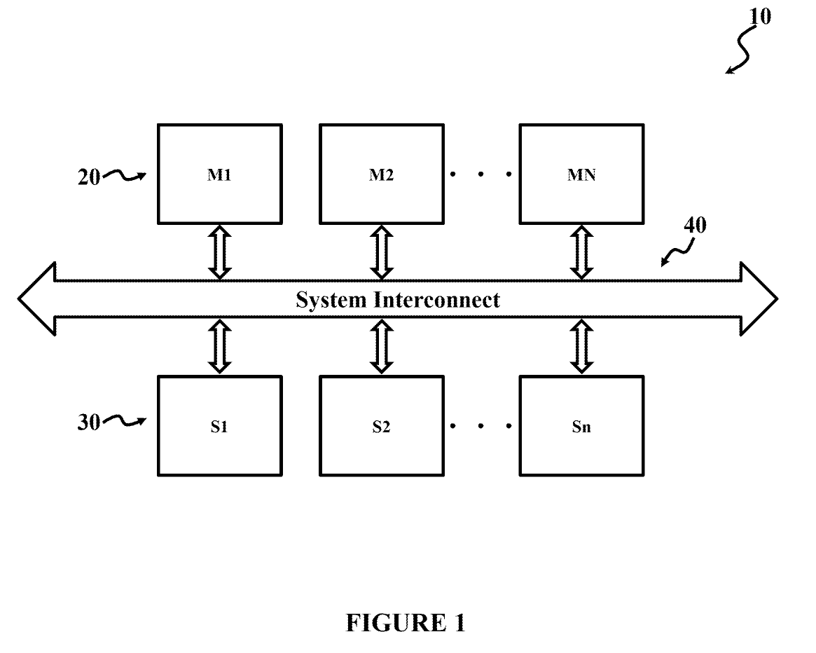

FIG. 1 is a schematic block diagram of an exemplary processing system 10 according to various aspects of the present disclosure. Processing system 10 depicts a multi-master processing environment, which is configured to enhance synchronization of shared resource access by semaphore-capable and non-semaphore capable masters. FIG. 1 has been simplified for the sake of clarity to better understand the inventive concepts of the present disclosure. Additional features can be added in processing system 10, and some of the features described can be replaced or eliminated in other embodiments of processing system 10.

Processing system 10 includes masters 20, such as M1, M2, . . . MN (where N is a total number of masters), and slaves 30, such as S1, S2, . . . Sn (where n is a total number of slaves). Masters 20 include any processing system component that can initiate a bus transaction, such as a central processing unit (CPU), a microcontroller, a microprocessor, a digital signal processor (DSP), a direct memory access (DMA) module, a system debug unit module, or other interconnect or system bus master. Slaves 30 include any processing component activated by a bus transaction, such as a memory, a controller (such as a memory controller), an input/output (I/O) module (any type of device that receives or provides information to processing system 10), a peripheral, other interconnect, or system bus slave. Memory can include a flash memory, a random access memory (RAM), a read only memory (ROM), a dynamic RAM (DRAM), a static RAM (SRAM), a synchronous DRAM (SDRAM), a double data rate SDRAM (DDR SDRAM), a graphic DDR memory, a magnetoresistive RAM (MRAM), other type of memory, or combination thereof. In various implementations, a processing component can act as both a master and a slave. Note that processing system 10 can include any number of masters (one or more) and/or slaves (one or more).

A system interconnect 40 interconnects various components of processing system 10. For example, in the depicted embodiment, masters 20 and slaves 30 are coupled to system interconnect 40, such that masters 20 and slaves 30 can communicate with one another via the system interconnect 40. System interconnect 40 can include a single bus, multiple buses, a crossbar network, a single-stage network, a multistage network, other type of interconnection network, or combination thereof. In various implementations, system interconnect 40 can implement system crossbars (SCB) that form a switch-fabric style for system bus interconnection. For example, SCBs can connect system bus masters (such as masters 20) to system bus slaves (such as slaves 30) to provide concurrent data transfer between multiple bus masters and multiple bus slaves. The switch-fabric can include a matrix including multiple master interfaces and multiple slave interfaces.

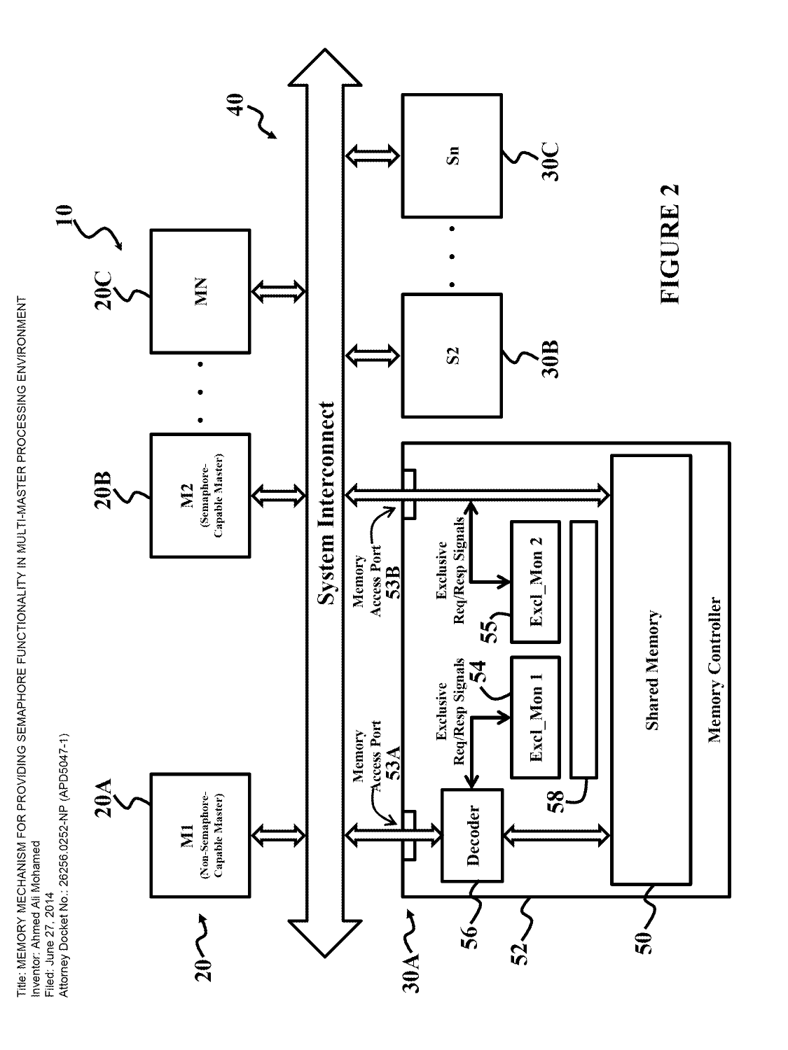

At least one slave 30 can be a shared resource in processing system 10, where more than one master 20 can access resources of the slave 30. During operation of processing system 10, semaphores can be implemented to manage and synchronize access to the shared resources (here, a shared slave 30). FIG. 2 is a schematic block diagram of an exemplary memory mechanism that supports semaphore functionality that can be implemented by processing system 10 of FIG. 1 according to various aspects of the present disclosure. In various implementations, the memory mechanism facilitates semaphore access (for example, exclusive access) to a shared resource in processing system 10 by both semaphore-capable masters and non-semaphore-capable masters. FIG. 2 has been simplified for the sake of clarity to better understand the inventive concepts of the present disclosure. Additional features can be added in the memory mechanism implemented by processing system 10, and some of the features described can be replaced or eliminated in other embodiments of the memory mechanism implemented by processing system 10.

In FIG. 2, processing system 10 includes both semaphore-capable masters and non-semaphore-capable masters. Non-semaphore-capable masters lack a semaphore mechanism, and thus, support only non-exclusive accesses, such as normal read/write instructions. In various implementations, non-semaphore-capable masters can include an ARM processor, such as an ARM® Cortex®-M0 processor; a DMA-capable peripheral; and/or other processing component lacking semaphore capability. Semaphore-capable masters include a semaphore mechanism, constructed from hardware and/or software associated with the semaphore-capable-master, which supports exclusive accesses (such as exclusive read/write instructions and/or exclusive load/exclusive store instructions) and/or locking accesses (such as locking read/write instructions). In various implementations, semaphore-capable masters can include a digital signal processor from Analog Devices, Inc., such as a Blackfin® digital signal processor; an ARM processor, such as an ARM® Cortex®-M4 processor; and/or other processing component having semaphore capability. Exclusive accesses are interruptible, generally referring to accesses that allow any number of masters to perform a read of a given memory location, while honoring a first exclusive write by a master to the memory location, such that subsequent exclusive write attempts to the memory location by other masters are discarded (in some instances, returning a fail status). In other words, when a first master asserts an exclusive read to a memory location, any other master can read and/or write to the memory location before the first master asserts the exclusive write. If another master asserts an exclusive write to the memory location before the first master, the first master's exclusive write to the memory location will be discarded, returning a fail status to the first master. Locking accesses (also referred to as atomic accesses) are uninterruptible, generally referring to accesses that prevent other masters from performing read or write accesses between one master's lock read and the same master's lock write. In other words, when a first master asserts a locking read to a memory location, no other master can read and/or write to the memory location until after the first master asserts a locking write. Locking accesses can sometimes cause performance bottleneck issues, since no other master can access the memory and/or memory location until after a master's locked access to the memory is complete.

In the depicted embodiment, masters 20 include a non-semaphore-capable master 20A (also designated as M1), a semaphore-capable master 20B (also designated as M2), and a master 20C (also designated as MN). Non-semaphore-capable master 20A is configured to perform only non-exclusive accesses, such as normal read and normal write; and semaphore-capable master 20B includes a semaphore mechanism, such that semaphore-capable master 20B is configured to perform exclusive accesses, such as exclusive read and exclusive write. The semaphore mechanism can generate an exclusive access control signal when the semaphore-capable master 20B requests access to a shared resource, such as a shared slave. In various implementations, as described further below, the semaphore-capable master is configured to generate exclusive access control signals to activate an exclusive mechanism that facilitates exclusive access, while the non-semaphore-capable master cannot generate exclusive access control signals to activate the exclusive mechanism. For example, semaphore-capable master can generate an exclusive read control signal.

Slaves 30 include a slave 30A, a slave 30B (also designated as S2), and a slave 30C (also designated as Sn). In the depicted embodiment, slave 30A is a memory unit shared by more than one master of processing system 10, and for the following discussion will be referred to as shared memory unit 30A. Shared memory unit 30A includes a shared memory 50 and a shared memory controller 52. Shared memory 50 can be accessed by any master 20, where shared memory controller 52 manages access to shared memory 50 (including managing data to/from shared memory 50). In the depicted embodiment, non-semaphore-capable master 20A can access shared memory 50 via a memory access port 53A, and semaphore-capable master 20B can access shared memory 50 via a memory access port 53B. In various implementations, shared memory unit 30A receives memory access requests from non-semaphore-capable master 20A on memory access port 53A (via system interconnect 40) and from semaphore-capable master 20B on memory access port 53B (via system interconnect 40), and performs memory access operations (for example, read, write, and/or other processing operation) associated with the memory access requests. Each memory access port can be configured (for example, with various terminals and/or leads) to carry control signals, address signals, and data signals to perform requested memory operations.

Shared memory unit 30A includes a semaphore memory mechanism that supports semaphore functionality in heterogeneous processing environments, such that, in the depicted embodiment, both non-semaphore-capable master 20A and semaphore-capable master 20B can perform exclusive accesses to shared memory 50. In particular, the semaphore memory mechanism includes a semaphore address command mechanism that can derive a semaphore command from memory access requests received from non-semaphore-capable masters. For example, shared memory controller 52 can examine memory access requests received from non-semaphore-capable master 20A and derive a semaphore command from the memory access request. Semaphore commands can include, but are not limited to, nonexclusive accesses (such as normal read, normal write), exclusive accesses (such as exclusive read, exclusive write), and/or locking accesses (such as locking read, locking write). Shared memory controller 52 can examine any signaling associated with the memory access request to derive the semaphore command, such as memory address, master ID, memory operation (for example, type of memory operation (read or write), size, length, bytes, etc.), or other signaling information associated with the memory access request. In various implementations, semaphore commands can be specified in a most significant bit (MSB) or bits of a memory address associated with a memory access request. In various implementations, the MSBs used for the semaphore command may be beyond address bits necessary to span an address space of shared memory 50.

In the depicted embodiment, shared memory controller 52 includes a decoder 56 coupled to memory access port 53A. Decoder 56 can receive a memory access request from non-semaphore-capable master 20A, and derive a semaphore command from an address associated with the memory access request. For example, decoder 56 can convert a memory address associated with the memory access request into memory access protocol signals for accessing the shared memory 50. When the semaphore command specifies nonexclusive access, decoder 56 can generate memory access protocol signals that facilitate a non-exclusive access of shared memory 50. When the semaphore command specifies exclusive access, decoder 56 can generate memory access protocol signals that facilitate exclusive access of shared memory 50. In various implementations, shared memory controller 52 generates exclusive access request signal(s) when the semaphore command specifies exclusive access (such as an exclusive read), providing semaphore functionality to non-semaphore capable master 20A.

In some embodiments, non-semaphore-capable master 20A is assigned two address ranges associated with shared memory 50—a normal access address space for performing normal memory access of shared memory 50 (in other words, non-exclusive read/write accesses), and an exclusive access address space for performing exclusive memory access of shared memory 50 (in other words, exclusive read/write accesses). Normal access address space can directly point to a physical address (or space) of shared memory 50. Exclusive memory access address space can point to a mirror image of the physical address space, and thus indirectly points to a physical address (or space) of shared memory. Essentially, such semaphore command arrangement can produce two aliased images of the mailbox memory in the processor memory space, one in which normal accesses occur, and another in which exclusive accesses occur. In an example, non-semaphore-capable master 20A can be assigned an address range ADR_RNG0 for use to perform normal memory accesses of shared memory 50, and an address range ADR_RNG1 for use to perform exclusive memory accesses of shared memory 50. When shared memory controller 52 receives a memory access request from non-semaphore-capable master 20A via memory access port 53A, decoder 56 derives an address associated with the memory access request and determines whether the address belongs to address range ADR_RNG0 or address range ADR_RNG1. When the address belongs to ADR_RNG0, decoder 56 determines that non-semaphore-capable master is requesting non-exclusive access, and decoder 56 can generate memory access protocol signals that facilitate a non-exclusive access to shared memory 50. When the address belongs to ADR_RNG1, decoder 56 determines that non-semaphore-capable master 20A is requesting exclusive access, and decoder 56 can generate memory access protocol signals that facilitate exclusive access to shared memory 50. For example, decoder 56 can generate a physical address to be accessed by non-semaphore-capable master 20A, and shared memory controller 52 can generate exclusive access request signal(s) to facilitate exclusive access of the physical address. Here, memory access port 53A to shared memory 50 can thus support various encoded semaphore commands—normal read, normal write, exclusive read, and exclusive write. In various implementations, the semaphore command is encoded in a most significant bit (MSB) of an address associated with the memory access request and/or memory operation control line(s) (such as a memory read/write control line). Essentially, semaphore commands are implemented using ordinary, normal memory operations, such as normal read/write (also referred to as normal load/store) operations.

The semaphore memory mechanism further includes a semaphore context monitor for each master having access to shared memory 50. For example, in the depicted embodiment, shared memory controller 52 includes a semaphore context monitor 54 associated with non-semaphore-capable master 20A and a semaphore context monitor 55 associated with semaphore-capable master 20B. Semaphore context monitor 54 and semaphore context monitor 55 implement an exclusive mechanism to facilitate exclusive memory accesses, such as exclusive read and/or exclusive write operations, of shared memory 50 respectively by non-semaphore-capable master 20A and semaphore-capable master 20B. In various implementations, semaphore context monitor 54 and semaphore context monitor 55 are finite state machines. Semaphore-capable master 20B can perform exclusive accesses by asserting exclusive access request signal(s), such as an exclusive read request signal, that activate associated semaphore context monitor 55. The exclusive access request signal(s) can accompany a memory access request received by shared memory controller 52 from semaphore-capable master 20B. In contrast, non-semaphore-capable master 20A can perform exclusive accesses when shared memory controller 52 generates exclusive access request signal(s) that activate associated semaphore context monitor 54. As described above, shared memory controller 52 will generate exclusive access request signal(s) when a semaphore command derived from a memory access request received from non-semaphore-capable master 20A specifies exclusive access. For example, the semaphore command specifies an exclusive read request.

The semaphore memory mechanism further includes a semaphore status mechanism configured to return a status of an exclusive access, such as an exclusive write, to a master. The semaphore statues mechanism can include a register status bit (such as a memory-mapped register status bit), an interrupt line, a memory bus error-response signal, or any other mechanism for notifying a master of its exclusive access status. In the depicted embodiment, the semaphore status mechanism can include a semaphore status register 58 that includes a status bit indicating exclusive access status of a master. In various implementations, semaphore status register 58 includes a status bit(s) associated with non-semaphore-capable master 20A. In various implementations, the semaphore status mechanism further or alternatively includes an interrupt (trigger) line that can be coupled to the semaphore status register 58, such that non-semaphore-capable master 20A is notified of its exclusive write response success via an exclusive response signal(s). In various implementations, shared memory controller 52 can report exclusive response signal(s) associated with non-semaphore-capable master to semaphore status register 58.

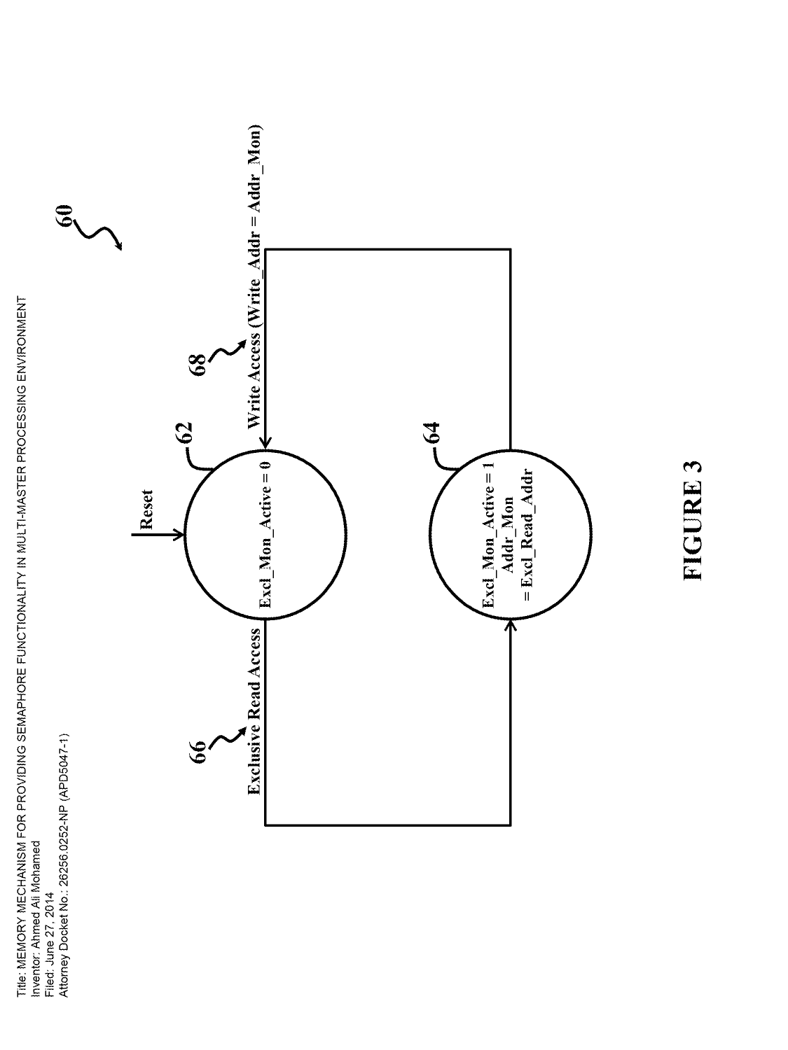

FIG. 3 is a state diagram for an exclusive mechanism 60 that can be implemented in the memory mechanism of FIG. 2 according to various aspects of the present disclosure. In the depicted embodiment, semaphore context monitor 54 and semaphore context monitor 55 each have an associated exclusive mechanism 60. FIG. 3 has been simplified for the sake of clarity to better understand the inventive concepts of the present disclosure. Additional features can be added in the exclusive mechanism 60 implemented by processing system 10, and some of the features described can be replaced or eliminated in other embodiments of the exclusive mechanism 60 implemented by processing system 10.

In FIG. 3, exclusive mechanism 60 has one of two states: exclusive monitor inactive state 62 or exclusive monitor active state 64. An exclusive read access 66 by a master activates an exclusive monitor associated with the master, such that exclusive mechanism 60 changes from exclusive monitor inactive state 62 (for example, Excl_Mon_Active=0) to exclusive monitor active state 64 (for example, Excl_Mon_Active=1) and stores an address associated with the exclusive read access 66 (for example, Addr_Mon=Excl_Read_Addr). Any write access 68, whether an exclusive write or non-exclusive write, to the address stored by the exclusive mechanism 60 (for example, Write_Addr=Addr_Mon) results in deactivating the exclusive monitor, such that exclusive mechanism 60 changes from exclusive monitor active state 64 (for example, Excl_Mon_Active=1) to exclusive monitor inactive state 62 (for example, Excl_Mon_Active=0). The master associated with the exclusive monitor successfully performs an exclusive write access when the exclusive monitor is activated (for example, Excl_Mon_Active=1) and an address associated with the exclusive write access matches the address stored by the exclusive monitor (for example, Write_Addr=Addr_Mon). Exclusive write accesses will propagate to shared memory 50, while shared memory unit 30a ignores failed exclusive write accesses. In various implementations, exclusive mechanism 60 can be implemented as a register that stores a value of 0 when in exclusive monitor inactive state 62 and a value of 1 when in exclusive monitor active state 64.

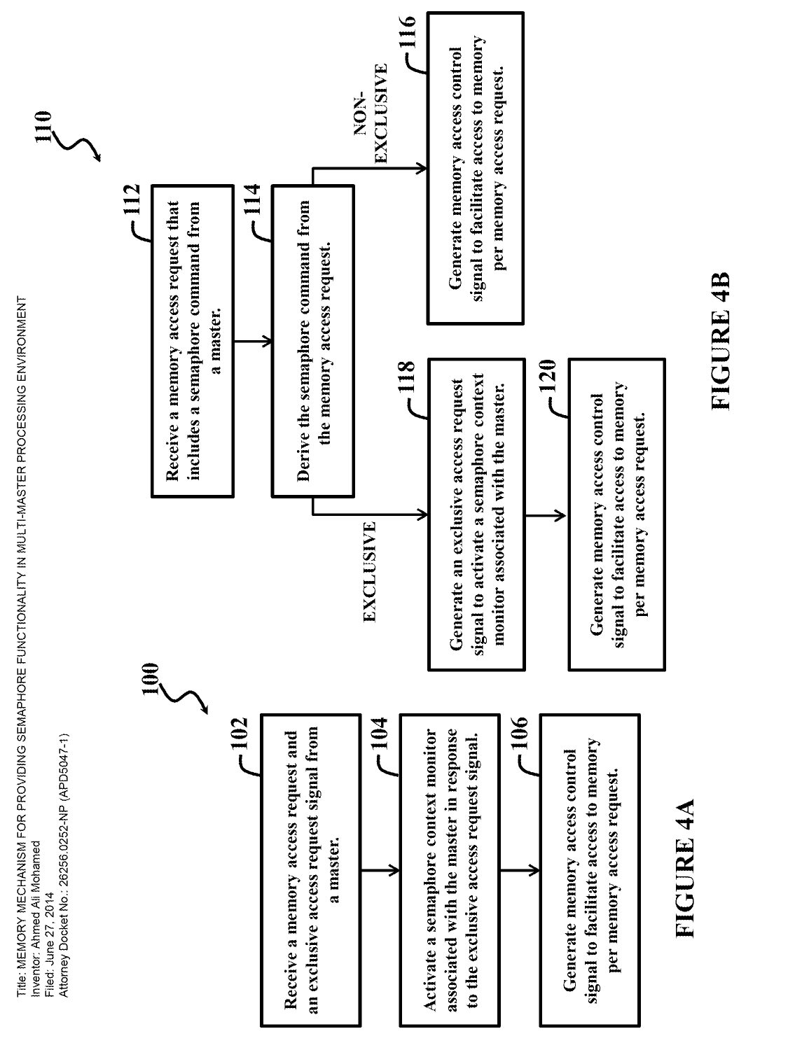

FIG. 4A is a flowchart of an exemplary method 100 for supporting exclusive access of a shared resource by a semaphore-capable master of a processing system, such as the processing system 10 described with reference to FIG. 1, FIG. 2, and FIG. 3, according to various aspects of the present disclosure. In various implementations, shared memory unit 30A implements method 100 to support exclusive access of shared memory 50 by semaphore-capable master 20B. At block 102, a memory access request and an exclusive access request signal is received from a master in a processing system. For example, shared memory controller 52 receives a memory access request and an exclusive access request signal (such as an exclusive read request signal) from semaphore-capable master 20B. The exclusive access request signal may accompany the memory access request. At block 104, a semaphore context monitor associated with the master is activated in response to the exclusive access request signal. For example, semaphore context monitor 55 is activated by the exclusive read request signal received by shared memory controller 52 from semaphore-capable master 20B. At block 106, a memory access control signal is generated to facilitate access to a memory per the memory access request. For example, shared memory controller 52 generates memory access control signals to allow semaphore-capable master 20B access to shared memory 50 per the memory access request. In various implementations, the method can further include notifying the master of exclusive access status. For example, shared memory controller 52 can report success of an exclusive write access to semaphore-capable master 20B. Additional steps can be provided before, during, and after method 100 and some of the steps described can be replaced or eliminated for other embodiments of method 100. Furthermore, the present disclosure contemplates that the master and/or shared resource can include any processing component of the processing system.

FIG. 4B is a flowchart of an exemplary method 110 for supporting exclusive access of a shared resource by a non-semaphore-capable master of a processing system, such as the processing system 10 described with reference to FIG. 1, FIG. 2, and FIG. 3, according to various aspects of the present disclosure. In various implementations, shared memory unit 30A implements method 110 to support exclusive access of shared memory 50 by non-semaphore-capable master 20A. At block 112, a memory access request is received from a master in a processing system. The memory access request includes a semaphore command. For example, shared memory controller 52 receives a memory access request from non-semaphore-capable master 20A. The memory access request can have an associated memory address that includes the semaphore command. At block 114, the semaphore command is derived from the memory access request. For example, shared memory controller derives the semaphore command from the memory address. The semaphore command specifies a type of memory access. At block 116, if the semaphore command specifies a non-exclusive access (such as a normal read or a normal write), a memory access control signal is generated to facilitate access to a memory per the memory access request. For example, shared memory controller 52 generates memory access control signals to allow non-semaphore-capable master 20A access to shared memory 50 per the memory access request. At block 118, if the semaphore command specifies an exclusive access, an exclusive access control signal is generated to activate a semaphore context monitor associated with the master. For example, when the semaphore command specifies an exclusive read, semaphore context monitor 54 is activated by an exclusive read request signal generated by shared memory controller 52. At block 120, a memory access control signal is generated to facilitate access to a memory per the memory access request. For example, shared memory controller 52 generates memory access control signals to allow non-semaphore-capable master 20A access to shared memory 50 per the memory access request. In various implementations, the method can further include reporting exclusive access status to the shared memory controller 52. In various implementations, the method can further include notifying the master of exclusive access status. For example, shared memory controller 52 can report success of an exclusive write to non-semaphore-capable master 20A. Non-semaphore-capable master 20A successfully performs an exclusive write when semaphore context monitor 54 is in an active state and non-semaphore-capable master 20A writes to a memory address stored by semaphore context monitor 54 (specified in the memory access request). In various implementations, if any write access has been performed to the memory address stored by semaphore context monitor 54 before non-semaphore-capable master 20A writes to the memory address, then semaphore context monitor 54 will enter an inactive state, such that an exclusive write by the non-semaphore-capable master 20A fails. Additional steps can be provided before, during, and after method 110 and some of the steps described can be replaced or eliminated for other embodiments of method 110. Furthermore, the present disclosure contemplates that the master and/or shared resource can include any processing component of the processing system.

In various implementations, a processing system includes a shared memory unit that can be implemented as a shared mailbox memory that supports exclusive access. The shared mailbox memory can include two memory-mapped data ports shared between a semaphore-capable master and a non-semaphore capable master. In various implementations, the processing system can implement a communications protocol that supports only normal memory accesses (for example, read/write accesses), such as AMBA APB protocol. The semaphore-capable master can implement exclusive load/exclusive store hardware instructions, enabling memory bus accesses that use exclusive access control signals. The non-semaphore-capable master can be assigned an alias address range that enables exclusive accesses. An alias address can be translated by the mailbox memory to enable exclusive access. In various implementations, by initiating a regular memory address read/write using an alias address associated with the alias address range, the non-semaphore-capable master can perform exclusive accesses typically not supported by non-semaphore-capable master. In various implementations, a status register bit can be read and reported to the non-semaphore-capable master to notify the non-semaphore-capable master of its exclusive write response.

In various implementations, processing system 10, components of processing system 10, and/or the various circuits and/or components of the FIGURES can be implemented on a board of an associated electronic device. The board can be a general circuit board that can hold various components of an electronic system of the electronic device and, further, provide connectors for other peripherals. The board can provide electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, other considerations, or a combination thereof. Other components, such as external storage, sensors, controllers for audio/video display, and peripheral devices may be attached to the board as plug-in cards, via cables, or integrated into the board itself. In various implementations, processing system 10, components of processing system 10, and/or the various circuits and/or components of the FIGURES can be implemented as stand-alone modules (for example, a device with associated components and circuitry configured to perform a specific application or function) or implemented as plug-in modules into application specific hardware of electronic devices.

Note that particular embodiments of the present disclosure may be readily included in a system-on-chip (SOC) package, either in part, or in whole. An SOC represents an integrated circuit that integrates components of a computer or other electronic system into a single chip. It may contain digital, analog, mixed-signal, and often radio frequency functions: all of which may be provided on a single chip substrate. For example, in various implementations, processing system 10 is implemented as a SOC, such that components of processing system 10 are integrated in a single chip. In various implementations, components of processing system 10 are implemented in a same device. Alternatively, components of processing system 10 can be distributed in various integrated circuits and/or devices interconnected with each other, such that components of processing system 10 are integrated to achieve the synchronization features described herein. Other embodiments may include a multi-chip-module (MCM), with a plurality of separate ICs located within a single electronic package and configured to interact closely with each other through the electronic package. In various other embodiments, the various functions described herein may be implemented in one or more semiconductor cores (such as silicon cores) in application specific integrated circuits (ASICs), field programmable gate arrays (FPGAs), other semiconductor chips, or combinations thereof.

The various functions outlined herein may be implemented by logic encoded in one or more non-transitory and/or tangible media (for example, embedded logic provided in an application specific integrated circuit (ASIC), as digital signal processor (DSP) instructions, software (potentially inclusive of object code and source code) to be executed by a processor, or other similar machine, etc.). In some of these instances, a memory element can store data used for the operations described herein. This includes the memory element being able to store logic (for example, software, code, processor instructions) that is executed by a processor to carry out the activities described herein. The processor can execute any type of instructions associated with the data to achieve the operations detailed herein. In various implementations, the processor can transform an element or an article (such as data) from one state or thing to another state or thing. In another example, the activities outlined herein may be implemented with fixed logic or programmable logic (such as software/computer instructions executed by the processor) and the elements identified herein can be some type of a programmable processor (such as a DSP), programmable digital logic (e.g., a FPGA, an erasable programmable read only memory (EPROM), an electrically erasable programmable ROM (EEPROM)), or an ASIC that includes digital logic, software, code, electronic instructions, or any suitable combination thereof.

Note that the activities discussed above with reference to the FIGURES are applicable to any integrated circuits that involve signal processing, particularly those that can execute specialized software programs or algorithms, some of which may be associated with processing digitized real-time data. Certain embodiments can relate to multi-DSP signal processing, floating point processing, signal/control processing, fixed-function processing, microcontroller applications, etc. In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems. Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can use high-precision data conversion products in battery monitoring, control systems, reporting controls, maintenance activities, etc. In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media device). Hence, such technologies could readily be a part of smartphones, tablets, security systems, PCs, gaming technologies, virtual reality, simulation training, etc.

The specifications, dimensions, and relationships outlined herein have only been offered for purposes of example and teaching only. Each of these may be varied considerably without departing from the spirit of the present disclosure, or the scope of the appended claims. The specifications apply only to non-limiting examples and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than a restrictive sense.

Note that with the numerous examples provided herein, interaction may be described in terms of two, three, four, or more processing components. However, this has been done for purposes of clarity and example only. It should be appreciated that the system can be consolidated in any suitable manner. Along similar design alternatives, any of the illustrated components, modules, circuits, and elements of the FIGURES may be combined in various possible configurations, all of which are clearly within the broad scope of this Specification. In certain cases, it may be easier to describe one or more of the functionalities of a given set of flows by only referencing a limited number of processing components. It should be appreciated that the processing components of the FIGURES and its teachings are readily scalable and can accommodate a large number of components, as well as more complicated/sophisticated arrangements and configurations. Accordingly, the examples provided should not limit the scope or inhibit the broad teachings of the processing system and/or components as potentially applied to a myriad of other architectures.

Further, note that references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. It is further noted that “coupled to” and “coupled with” are used interchangeably herein, and that references to a feature “coupled to” or “coupled with” another feature include any communicative coupling means, electrical coupling means, mechanical coupling means, other coupling means, or a combination thereof that facilitates the feature functionalities and operations described herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

### OTHER NOTES, EXAMPLES, AND IMPLEMENTATIONS

In various implementations, a system is provided. The system can include means for receiving a memory access request from a master; means for deriving a semaphore command from the memory access request; means for generating an exclusive request signal that activates a semaphore context monitor associated with the master when the semaphore command specifies exclusive access; and means for generating a memory access control signal to facilitate access to a shared memory. The system can further include means for receiving a memory access request from another master and an exclusive access request signal associated with the memory access request; means for activating a semaphore context monitor associated with the another master in response to the exclusive access request signal; means for generating a memory access control signal to facilitate access to the shared memory by the another master; and means for reporting an exclusive access status to the another master. The system may further include means for storing a memory address associated with the memory access request when the semaphore context monitor is activated, and deactivating the semaphore context monitor when another memory access request has an associated memory address that matches the stored memory address. The ‘means for’ in these instances can include (but is not limited to) using any suitable component discussed herein, along with any suitable software, circuitry, hub, computer code, logic, algorithms, hardware, controller, interface, link, bus, communication pathway, etc. In various implementations, the system includes memory that includes instructions that when executed cause the system to perform any of the activities discussed herein.

What is claimed is:

1. A memory unit for providing semaphore functionality in a multi-master processing environment, the memory unit comprising:
a memory controller that manages access to a shared memory, wherein the memory controller includes:
a semaphore context monitor associated with each master having access to the shared memory; and
a semaphore address command mechanism configured to derive a semaphore command from a memory access request received from a master and activate the semaphore context monitor associated with the master when the semaphore command specifies exclusive access.

2. The memory unit of claim 1, wherein the semaphore address command mechanism includes a decoder configured to derive the semaphore command from a memory address associated with the memory access request and generate a memory access control signal to facilitate access to the shared memory by the master.

3. The memory unit of claim 2, wherein the decoder is configured to generate an exclusive access request signal that activates the semaphore context monitor associated with the master when the semaphore command specifies exclusive read.

4. The memory unit of claim 2, wherein the decoder determines whether the memory address associated with the memory access request is directed to a first address range or a second address range, wherein the first address range indicates a normal access request and the second address range indicates an exclusive access request.

5. The memory unit of claim 4, wherein the semaphore address command mechanism is configured to generate an exclusive read request signal to activate the semaphore context monitor associated with the master when the memory address is directed at the second address range.

6. The memory unit of claim 1, wherein the semaphore context monitor has an active state and an inactive state, wherein the semaphore context monitor is configured to store a memory address associated with the memory access request when in the exclusive active state.

7. The memory unit of claim 6, wherein the semaphore context monitor is configured to enter the inactive state when the memory controller receives a memory write access request having an associated memory address that matches the memory address stored by the semaphore context monitor.

8. The memory unit of claim 1, wherein the memory controller further includes a semaphore status mechanism configured to return a status of an exclusive access to the master.

9. The memory unit of claim 1, wherein the memory controller includes:
a first semaphore context monitor associated with a non-semaphore-capable master, wherein the first semaphore context monitor is activated by an exclusive read request signal generated by the memory controller; and
a second semaphore context monitor associated with a semaphore-capable master, wherein the second semaphore context monitor is activated by an exclusive read request signal received from the semaphore-capable master.

10. A method for providing access to a memory unit, the method comprising:
receiving a memory access request from a master;
deriving a semaphore command from the memory access request;
generating an exclusive read request signal that activates a semaphore context monitor associated with the master when the semaphore command specifies exclusive access; and
generating a memory access control signal to facilitate access to a shared memory by the master.

11. The method of claim 10, wherein the semaphore command is derived from a memory address associated with the memory access request.

12. The method of claim 10, further including storing a memory address associated with the memory access request when the semaphore context monitor is activated.

13. The method of claim 12, further including deactivating the semaphore context monitor when a memory write request having an associated memory address that matches the stored memory address is received.

14. The method of claim 10, further including:
receiving a memory access request and an exclusive read request signal from another master;
activating a semaphore context monitor associated with the another master in response to the exclusive read request signal; and
generating a memory access control signal to facilitate access to the shared memory by the another master.

15. The method of claim 10, further including reporting an exclusive access status to the master.

16. A system for providing semaphore functionality in a in a multi-master processing environment, the system comprising:
a semaphore-capable master;
a non-semaphore-capable master; and
a memory unit that includes:
a memory, and
a memory controller that manages access to the memory by the semaphore-capable master and the non-semaphore-capable master, wherein the memory controller includes:
a first semaphore context monitor associated with the non-semaphore-capable master, wherein the first semaphore context monitor is activated by an exclusive read request signal generated by the memory controller; and
a second semaphore context monitor associated with the semaphore-capable master, wherein the second semaphore context monitor is activated by an exclusive read request signal received by the memory controller from the semaphore-capable master.

17. The system of claim 16, wherein the memory controller further includes a semaphore address command mechanism configured to derive a semaphore command from a memory access request received from the non-semaphore-capable master and activate the first semaphore context monitor when the semaphore command specifies an exclusive read.

18. The system of claim 17, wherein the semaphore address command mechanism includes a decoder.

19. The system of claim 16, wherein the first semaphore context monitor and the second semaphore context monitor each have:
an active state, wherein a memory address associated with an exclusive read access is stored by the semaphore context monitor when in the active state; and
an inactive state, wherein the semaphore context monitor enters the inactive state when the memory controller receives a memory write request having an associated memory address that matches the memory address stored by the semaphore context monitor.

20. The system of claim 16, wherein the memory controller further includes a semaphore status mechanism configured to return a status of an exclusive access to the non-semaphore-capable master.
